(19) United States
(12) Patent Application Publication
(10) Pub. No.: US 2022/0248588 A1
(43) Pub. Date: Aug. 11, 2022

(54) Two-handled Shovel

(71) Applicants: Khaled SHAHRIAR, Farmingdale, NY (US); Armando AGUILAR, East Northport, NY (US)

(72) Inventors: Khaled SHAHRIAR, Farmingdale, NY (US); Armando AGUILAR, East Northport, NY (US)

(21) Appl. No.: 17/566,628

(22) Filed: Dec. 30, 2021

Related U.S. Application Data
(60) Provisional application No. 63/132,413, filed on Dec. 30, 2020.

(51) Int. Cl. A01B 1/02

(52) U.S. Cl. CPC A01B 1/026

(57) ABSTRACT

A shovel includes a first shaft, a second shaft, and a shovel blade body. The shovel blade body has a concave front side, and a convex rear side having a shaft insert sleeve for receiving a lower end of the first shaft. The second shaft is configured to pivot relative to the first shaft, and can have adjustable length. A handle can be connected to an upper end of the second shaft and is rotatable. A toe push plate can be included proximate the shaft insert sleeve. The first shaft can be coupled to the shovel blade body with a spring. The cross section of the second shaft can be complementary to that of the first shaft so that the two shafts can be collapsed to be held by one hand comfortably.

### BACKGROUND OF INVENTION

Shovel is a common tool with a broad flat blade and typically upturned sides, used for moving earth snow or other material. While shoveling is a simple operation, the labor it involves can be physically challenging to many. Heavy duty shovels intended to lift and cavy heavy loads may cause severe pain in the wrist, arm or the back. Adding a second handle on the shovel can alleviate some of these problems, but currently available two-handled shovels still do not satisfactorily address issues in the areas of convenience, usability, and comfort.

### SUMMARY

In one aspect, the present disclosure provides a shovel, which includes: a first shaft having upper and lower ends defining a longitudinal axis; a first handle connected to the upper end of the first shaft; a shovel blade body having a distal edge, a concave front side and a convex rear side, the rear side coupled with a shaft insert sleeve for receiving the lower end of the first shaft; a second shaft defining a longitudinal axis, having upper and lower ends and configured to pivot relative to the first shaft, the lower end of the second shaft connected to the front side of the shovel blade body; and a second handle connected to the upper end of the second shaft and is rotatable along the longitudinal axis of the second shaft.

In some embodiments, the second handle can also be rotatable along an axis perpendicular to the longitudinal axis of the second shaft. For example, the second handle can be connected to the second shaft via a ball-in-socket joint.

In some embodiments, the first handle can be rotatable about the longitudinal axis of the first shaft.

In some embodiments, the lower end of the first shaft can be coupled with the blade body via a spring disposed inside the insert sleeve. The insert sleeve can include a slot on a side wall, wherein the lower end of the first shaft is provided with a locknut, the locknut exposing outside the slot and limiting motion of the first shaft in the insert sleeve in a longitudinal direction.

In some embodiments, the shovel can further include a toe push plate disposed at an upper end of the rear side of the shovel blade body. The toe push plate comprises an upper substantially flat face and two side supporting walls.

In some embodiments, the second shaft has an adjustable operating length.

In some embodiments, at least a portion of the second shaft has a cross-section shape complementary to the cross-section shape of at least a portion of the first shaft. For example, the cross-section shape of the portion of the first shaft can include an ellipse, and the cross-section shape of the portion of the second shaft can include an arc.

In another aspect, the present disclosure provides a shovel, which include: a first shaft having upper and lower ends defining a longitudinal axis; a first handle connected to the upper end of the first shaft; a shovel blade body having a distal edge, a concave front side and a convex rear side, the rear side coupled with a shaft insert sleeve for receiving the lower end of the first shaft; a second shaft defining a longitudinal axis, having upper and lower ends and configured to pivot relative to the first shaft, the lower end of the second shaft connected to the front side of the shovel blade body; a second handle connected to the upper end of the second shaft; and wherein the lower end of the first shaft is coupled with a spring disposed inside the insert sleeve.

In some embodiments, the insert sleeve comprises a slot on a side wall, wherein the lower end of the first shaft is provided with a locknut, the locknut exposing outside the slot and limiting motion of the first shaft in the insert sleeve in a longitudinal direction.

In some embodiments, at least a portion of the second shaft has a cross-section shape complementary to the cross-section shape of at least a portion of the first shaft.

In some embodiments, the shovel can further include a toe push plate disposed at an upper end of the rear side of the shovel blade body.

In some embodiments, the second shaft has an adjustable operating length.

In another aspect, the present disclosure provides a shovel, which includes: a first shaft having upper and lower ends defining a longitudinal axis; a first handle connected to the upper end of the first shaft; a shovel blade body having distal edges, a concave front side and a convex rear side, the rear side is connected with a shaft insert sleeve for receiving the lower end of the first shaft; a second shaft defining a longitudinal axis, having upper and lower ends and configured to pivot relative to the first shaft, the lower end of the second shaft connected at a point on the front side of the shovel blade body, the second shaft having an adjustable operating length; and a second handle connected to the upper end of the second shaft.

In some embodiments, the insert sleeve comprises a slot on a side wall, wherein the lower end of the first shaft is provided with a locknut, the locknut exposing outside the slot and limiting motion of the first shaft in the insert sleeve in a longitudinal direction.

In some embodiments, at least a portion of the second shaft has a cross-section shape complementary to the cross-section shape of at least a portion of the first shaft.

In some embodiments, the shovel can further include a toe push plate disposed at an upper end of the rear side of the shovel blade body.

### BRIEF DESCRIPTION OF THE DRAWINGS

FIGS. 1A and 1B are schematic views of a two-handled shovel according to embodiments of the invention.

FIG. 2 illustrates the degrees of freedom of two arms of a two-handled shovel according to embodiments of the invention.

FIG. 3A is a schematic cross-sectional view of coupling of a first shaft with a spring in an insert sleeve, according to embodiments of the invention.

FIG. 3B is a schematic perspective view of coupling of a first shaft with a spring in an insert sleeve, according to embodiments of the invention.

FIG. 4 is a schematic exploded view showing coupling structure of a second shaft, allowing the adjustment of its operating length, according to embodiments of the invention.

FIGS. 5A, 5B and 5C illustrate the structure and use of a toe push plate of the shovel according to embodiments of the invention.

FIG. 6 is a schematic cross-sectional view of two shafts of an embodiment of the shovel of the present invention.

### DETAILED DESCRIPTION OF EMBODIMENTS OF THE INVENTION

This disclosure provides a two-handled shovel for shoveling snow, mud, debris or objects of the sort. The description is accompanied by drawings where like reference numerals denote like elements.

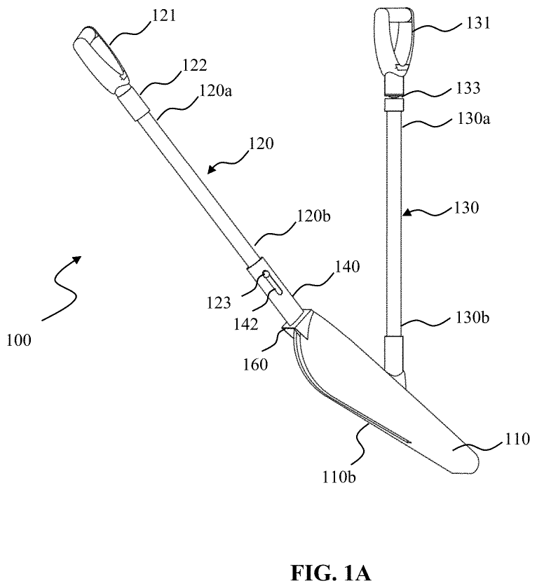

Referring to FIGS. 1a, 1b, 2, 3a and 3b, exemplary embodiments of a two-handled shovel 100 of the present invention includes a first (primary) arm (or shaft) 120 having an upper end 120a and lower end 120b, and second arm (or shaft) 130 having an upper end 130a and lower end 130b. The shovel blade 110 has a distal edge 110e, a concave front side 110a and a convex rear side 110b, the rear side 110b is coupled with an insert sleeve 140 for receiving the lower end of the first shaft 120. The first shaft 120 joins the blade body 110 through the insert sleeve 140. The second arm joins the blade body 110 at the anterior side of the blade body through a mount 131.

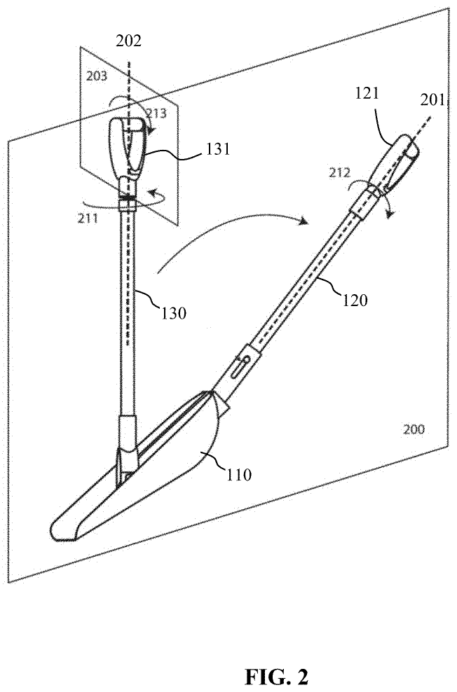

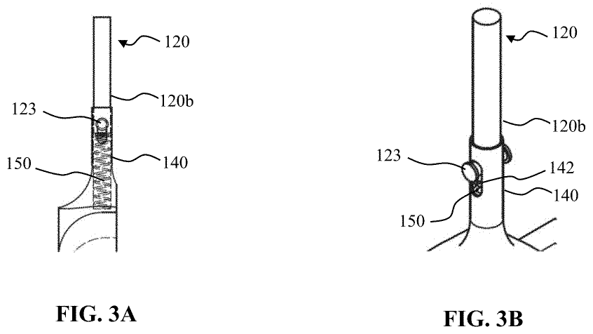

The primary shaft (which can be a cylindrical shaft) 120 is inserted into sleeve 140 which is connected to the blade body 110 at a rear-side upper part. A spring 150 (not shown in FIGS. 1/2, but shown in FIGS. 3a and 3b) is located inside the cylindrical housing of the sleeve 140, which has a side slot 142. A locknut 123 is located at the lower end of the primary shaft 120 and exposes outside the sot 142, and can move within the limited length of the slot 142. In this manner, the spring 150 located inside the sleeve 140 allows for a spring assisted motion for the primary shaft 120, which can create a hammer-drilling effect on the otherwise restricted access for the shovel, thus helps to attack the scooping. The spring-assisted primary shaft can also help to shake off the remnant debris that stick to the shovel body.

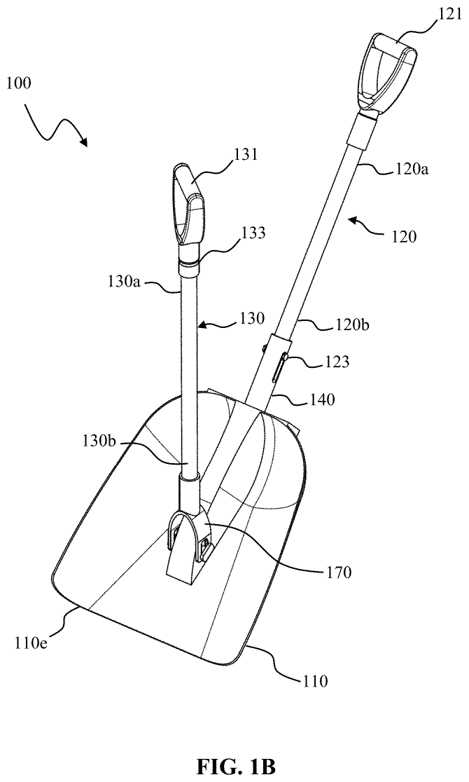

The primary handle 121 connected on the upper end 120a of the primary shaft 120 can swivel at joint 122 (see FIG. 2).

The second shaft 130 can be inserted into a mount 170 which has two opposing sockets on both sides to be inserted into two opposing tabs on a mounting base structure at the anterior side of the shovel body 110, creating a pivotal joint which allows the second shaft 130 to pivot relative to the first shaft 120. The position of the mount 170 can be at or proximal to the center of the blade body, which provides an optimal balance for the lifting of the shovel when the shovel blade 110 is filled with a heavy load, such as snow.

A second handle 131 is connected at the upper end 130a of the second shaft 130 with a joint 133, which can allow handle 131 to rotate about the pivoting shaft 130 (see FIG. 2).

FIG. 2 illustrates degrees of freedom of both the first and second shafts. The two shafts 120 and 130 form a plane 200. The first shaft has a longitudinal axis 201, and the second shaft has a second axis 202. The second shaft 130 can pivot along the plane 200 toward or away from the first shaft 120. The primary handle 121 can swivel in path 212 about the axis 201. The secondary handle 131 can rotate about the axis 202 on a path 211. If the second handle 131 and the second shaft 130 is joined by ball-socket type joint, the second handle 131 can also tilt on a path 213 on any plane 203 intersecting plane 200 that the rotation of 211 creates. That is, the second handle can also rotate about an axis perpendicular to the longitudinal axis of the second shaft. This creates comfort and allows the maximum human ability to lift and dispose the shoveled load with ease and efficiency.

In some embodiments, the first handle 121 and the first shaft 120 can also be joined in a ball-socket type joint that allows its rotation about axis 201 and tilt from axis 201.

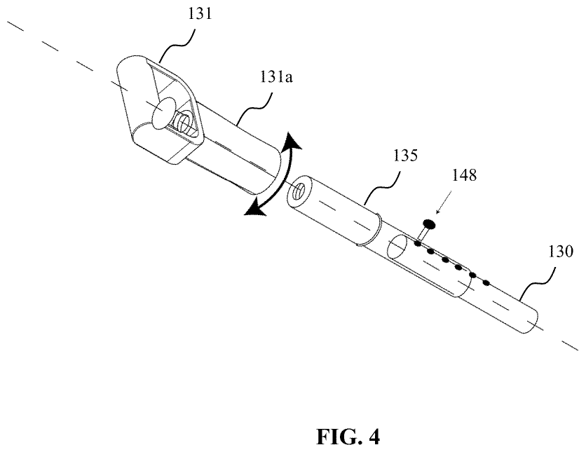

In some embodiments, the second shaft can have an adjustable operating length. As illustrated in FIG. 4, the second handle 131 includes an extended cylindrical portion 131a, which can be cylindrically coupled with a hollow cylindrical connector 135, which in turn can be coupled with second cylindrical shaft 130, which has a series of open holes on its side wall on the upper end, and can be inserted into the hollow connector 135. The second shaft 130 can be slid up and down the connector 135, and the coupling position between the two parts can be fixed by a bolt or pin 148 which goes through a hole on the side wall of the connector 135 and one of the series of holes on the second shaft 130, thereby adjusting the operating length of the second shaft 130 (the length between the second handle and the shovel blade body).

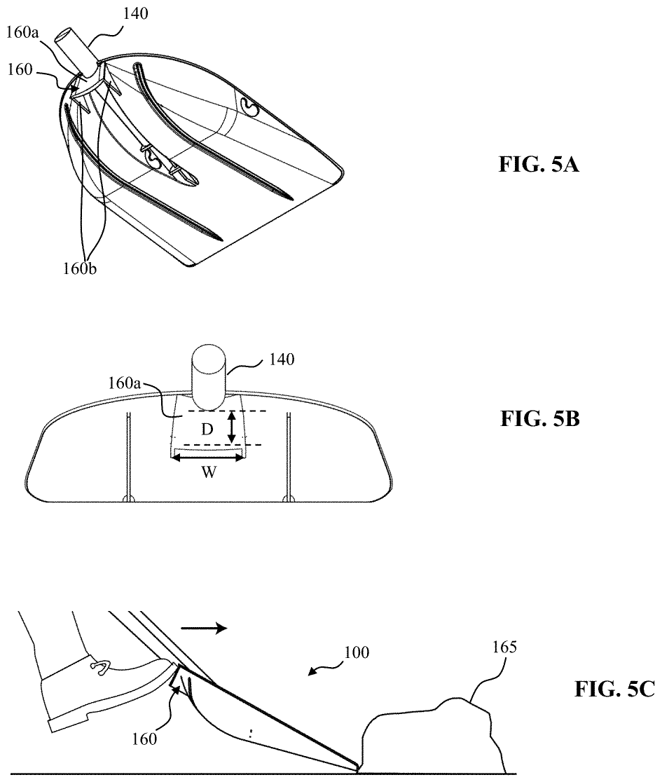

As shown in FIGS. 5A-5C, the shovel can further include a toe push plate 160 located on the center upper rear side of the shovel blade body 110 and proximal the insert sleeve 140. The toe push plate can include an upper substantially flat surface 160a, and two side support walls 160b which are joined to the rear side of the blade body. The toe plate provides a suitable spot for a user to push the shovel blade easily, which can be especially useful to tackle hard object 165. The toe push plate can be constructed by a metal or other hard impact-withstanding material. Preferably, the upper surface of the toe push plate should have a sufficient depth D (shown in FIG. 5B) for the user to engage the push plate, for example at least 2 inches, at least 3 inches or greater. The width W of the upper surface of the toe push plate can be 4 inches to 6 inches.

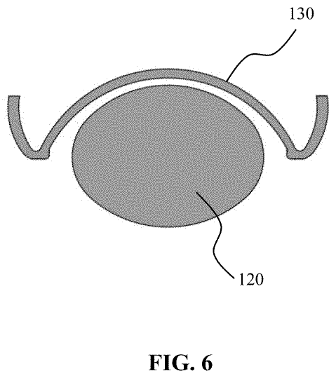

In some embodiments, at least a portion of the second shaft has a cross-section shape complementary to the cross-section shape of at least a portion of the first shaft, such that the first and second shafts can, at the ultimate closed pivot position, collapse together to form a unitary structure to be held by one hand of the user comfortably. For example, the cross-section shape of the portion of the first shaft 120 can include an ellipse (which includes a circle), and the cross-section shape of the portion of the second shaft 130 can include an arc section, as shown in FIG. 6.

It is understood that the various features of the shovel disclosed herein, such as adjustable operating length of the second shaft, the swiveling capability of the second handle, the spring-assistant feature for the first shaft, the first and second shafts being collapsible to form one generally, can be combined in any desired manner.

While the invention has been disclosed with reference to specific embodiments, it is apparent that other embodiments and variations of this invention may be devised by others skilled in the art without departing from the true spirit and scope of the invention. The appended claims are intended to be construed to include all such embodiments and equivalent variations.

1. A shovel, comprising:
a first shaft having upper and lower ends defining a longitudinal axis;
a first handle connected to the upper end of the first shaft;
a shovel blade body having a distal edge, a concave front side and a convex rear side, the rear side coupled with a shaft insert sleeve for receiving the lower end of the first shaft;
a second shaft defining a longitudinal axis, having upper and lower ends and configured to pivot relative to the first shaft, the lower end of the second shaft connected to the front side of the shovel blade body; and
a second handle connected to the upper end of the second shaft and is rotatable along the longitudinal axis of the second shaft.

2. The shovel of claim 1, wherein the second handle is also rotatable along an axis perpendicular to the longitudinal axis of the second shaft.

3. The shovel of claim 1, where the second handle is connected to the second shaft via a ball-in-socket joint.

4. The shovel of claim 1, wherein the first handle is rotatable about the longitudinal axis of the first shaft.

5. The shovel of claim 1, wherein the lower end of the first shaft is coupled with the shovel blade body via a spring disposed inside the insert sleeve.

6. The shovel of claim 5, wherein the insert sleeve comprises a slot on a side wall, wherein the lower end of the first shaft is provided with a locknut, the locknut exposing outside the slot and limiting motion of the first shaft in the insert sleeve in a longitudinal direction.

7. The shovel of claim 1, further comprising a toe push plate disposed at an upper end of the rear side of the shovel blade body.

8. The shovel of claim 1, wherein the toe push plate comprises an upper substantially flat face and two side supporting walls.

9. The shovel of claim 1, wherein the second shaft has an adjustable operating length.

10. The shovel of claim 1, wherein at least a portion of the second shaft has a cross-section shape complementary to the cross-section shape of at least a portion of the first shaft.

11. The shovel of claim 10, wherein the cross-section shape of the portion of the first shaft comprises an ellipse, and the cross-section shape of the portion of the second shaft comprises an arc.

12. A shovel, comprising:
a first shaft having upper and lower ends defining a longitudinal axis;
a first handle connected to the upper end of the first shaft;
a shovel blade body having a distal edge, a concave front side and a convex rear side, the rear side coupled with a shaft insert sleeve for receiving the lower end of the first shaft;
a second shaft defining a longitudinal axis, having upper and lower ends and configured to pivot relative to the first shaft, the lower end of the second shaft connected to the front side of the shovel blade body;
a second handle connected to the upper end of the second shaft; and
wherein the lower end of the first shaft is coupled with a spring disposed inside the insert sleeve.

13. The shovel of claim 12, wherein the insert sleeve comprises a slot on a side wall, wherein the lower end of the first shaft is provided with a locknut, the locknut exposing outside the slot and limiting motion of the first shaft in the insert sleeve in a longitudinal direction.

14. The shovel of claim 12, wherein at least a portion of the second shaft has a cross-section shape complementary to the cross-section shape of at least a portion of the first shaft.

15. The shovel of claim 12, further comprising a toe push plate disposed at an upper end of the rear side of the shovel blade body.

16. The shovel of claim 12, wherein the second shaft has an adjustable operating length.

17. A shovel, comprising:
a first shaft having upper and lower ends defining a longitudinal axis;
a first handle connected to the upper end of the first shaft;
a shovel blade body having distal edges, a concave front side and a convex rear side, the rear side is connected with a shaft insert sleeve for receiving the lower end of the first shaft;
a second shaft defining a longitudinal axis, having upper and lower ends and configured to pivot relative to the first shaft, the lower end of the second shaft connected at a point on the front side of the shovel blade body, the second shaft having an adjustable operating length; and
a second handle connected to the upper end of the second shaft.

18. The shovel of claim 17, wherein the insert sleeve comprises a slot on a side wall, wherein the lower end of the first shaft is provided with a locknut, the locknut exposing outside the slot and limiting motion of the first shaft in the insert sleeve in a longitudinal direction.

19. The shovel of claim 17, wherein at least a portion of the second shaft has a cross-section shape complementary to the cross-section shape of at least a portion of the first shaft.

20. The shovel of claim 17, further comprising a toe push plate disposed at an upper end of the rear side of the shovel blade body.
